(19) United States
(12) Patent Application Publication
(10) Pub. No.: US 2011/0182643 A1
(43) Pub. Date: Jul. 28, 2011

(54) Keycap and Keyboard Using the Same

(75) Inventor: Tsai-Jung Hu, Pingzhen City (TW)

(73) Assignee: DARFON ELECTRONICS CORP., Taoyuan Shien (TW)

(21) Appl. No.: 13/014,959

(22) Filed: Jan. 27, 2011

(30) Foreign Application Priority Data
Jan. 28, 2010 (TW) 99201790

(51) Int. Cl. B41J 5/00

(52) U.S. Cl. 400/490

(57) ABSTRACT

A keycap including a body and an ink layer is provided. The ink layer is disposed on the body, and has a blind hole and a through hole.

This application claims the benefit of Taiwan application Serial No. 99201790, filed Jan. 28, 2010, the subject matter of which is incorporated herein by reference.

### BACKGROUND OF THE INVENTION

1. Field of the Invention

The invention relates in general to a keycap and a keyboard using the same, and more particularly to a keycap whose outward appearance is improved and a keyboard using the same.

2. Description of the Related Art

Nowadays, the application of a keyboard is very popular. The keyboard plays an important role in the input and editing of data as well as the operation of games. However, the keyboards currently available in the market are normally lack of design sense and variation, and are thus unable to show the consumer's personal tastes and characteristics. Thus, the keyboard is hard to become prominent among so many choices, and the product competitiveness is hard to improve. Therefore, how to provide different designs of the keyboards to attract the consumers' attention among various choices has become an imminent issue to the industries.

### SUMMARY OF THE INVENTION

The invention is directed to a keycap and a keyboard using the same, which provide different designs of the keyboard to attract consumers' attention, hence enhancing product competitiveness.

According to a first aspect of the present invention, a keycap including a body and a first ink layer is provided. The first ink layer is disposed on the body, and has a blind hole and a first through hole.

According to a second aspect of the present invention, a keyboard including a base and several key groups is provided. The key groups are disposed on the base. Each of the key groups includes a restoring mechanism and a keycap. The restoring mechanism is movably disposed on the base. The keycap is coupled onto the restoring mechanism. The keycap includes a body and a first ink layer. The first ink layer is disposed on the body. The first ink layer of at least one of the key groups has a blind hole and a first through hole.

The above and other aspects of the invention will become better understood with regard to the following detailed description of the preferred but non-limiting embodiment(s). The following description is made with reference to the accompanying drawings.

### BRIEF DESCRIPTION OF THE DRAWINGS

FIG. 1A shows a top view of a key group according to a first embodiment of the present invention;

FIG. 1B shows a cross-sectional view of the key group along line 1B-1B in FIG. 1A;

FIG. 1C shows an enlargement of the region in FIG. 1B;

FIG. 2A shows a top view of a key group according to a second embodiment of the present invention;

FIG. 2B shows a cross-sectional view of the key group along line 2B-2B in FIG. 2A;

FIG. 2C shows an enlargement of the region in FIG. 2B; and

FIG. 3 shows a schematic view of a keyboard according to a third embodiment of the present invention.

### DETAILED DESCRIPTION OF THE INVENTION

A number of embodiments and accompanying drawings are disclosed below for elaborating a keycap and a keyboard using the same according to the invention. Anyone who is skilled in the technology of the invention will understand that the drawings and disclosure are for detailed description of the invention not for limiting the scope of protection of the invention.

### First Embodiment

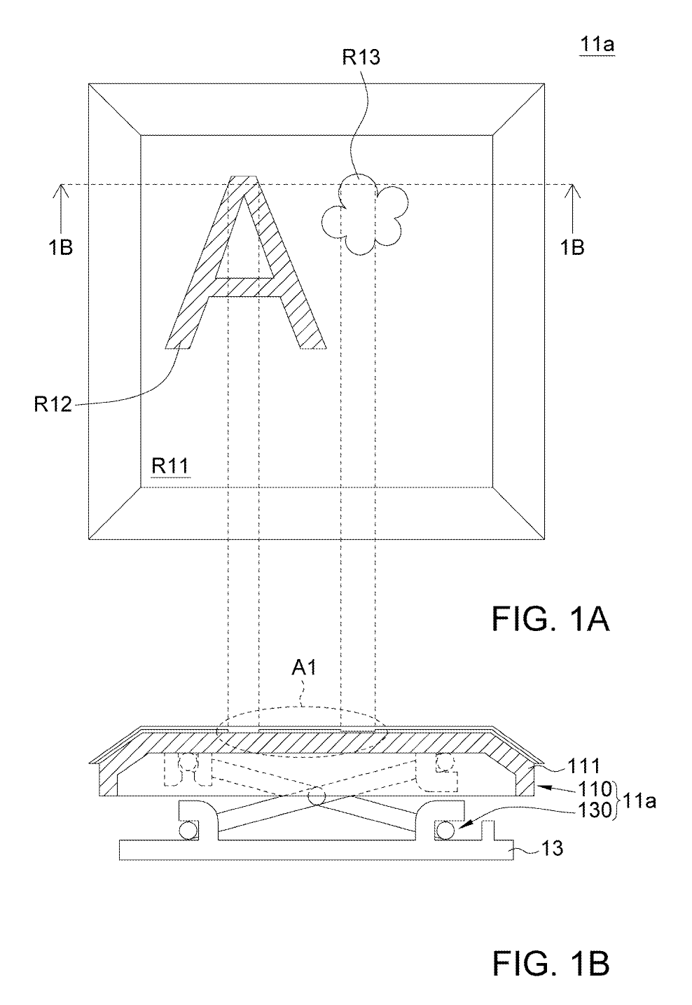

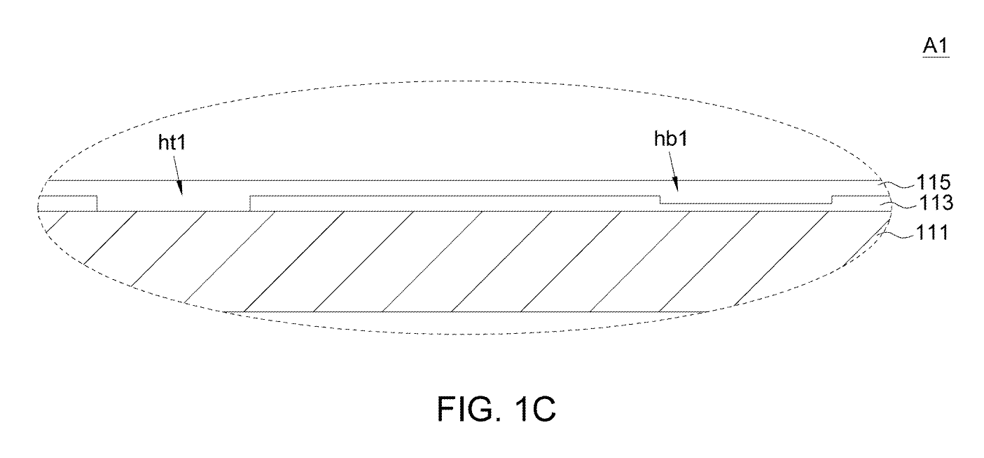

Referring to FIG. 1A˜1C, a top view of a key group 11a according to a first embodiment of the present invention is shown in FIG. 1A, a cross-sectional view of the key group 11a along line 1B-1B in FIG. 1A is shown in FIG. 1B, and an enlargement of the region A1 in FIG. 1B is shown in FIG. 1C.

The key group 11a is disposed on a base 13 and includes a keycap 110 and a restoring mechanism 130. The restoring mechanism 130 is movably disposed on the base 13. The keycap 110 is coupled onto the restoring mechanism 130. Thus, once the user presses the keycap 110, the restoring mechanism 130 provides a restoring force for returning the keycap 110 to its initial position.

The keycap 110 includes a body 111 and a first ink layer 113. The first ink layer 113 is disposed on the body 111, and has a blind hole hb1 and a first through hole ht1. Thus, the body 111 is exposed from the first through hole ht1.

The first through hole ht1 and the blind hole hb1 can be designed to form special patterns respectively on different regions of the keycap 110. For example, as indicated in FIG. 1A, the first through hole ht1 is designed to form an English letter “A” (region R12), and the blind hole hb1 is designed to form a floral pattern (region R13). Since the depth of the first through hole ht1 is different from that of the blind hole hb1, and the structure exposed from the first through hole ht1 is different from that exposed from the blind hole hb1, different effects of lights and colors are formed. In comparison to an ordinary keycap, the keycap 110 of the present embodiment of the invention is more versatile and aesthetic in terms of outward appearances, and is more attractive to the user.

To further highlight the shape of the first through hole ht1 and increase the flexibility in disposition, the body 111 and the first ink layer 113 may have different colors. In addition, the keycap 110 of the present embodiment of the invention may further include a protection layer 115 disposed on the first ink layer 113 to protect the first ink layer 113. Preferably, the protection layer 115 is made from a transparent material so that the first through hole ht1 and the blind hole hb1 of the first ink layer 113 can be revealed.

With the formation of the first through hole ht1 and the blind hole hb1 of the first ink layer 113, the keycap 110 of the present embodiment of the invention provides different choices of disposition with the regions R11, R12 and R13, wherein the region R12 corresponds to the first through hole ht1, and the region R13 corresponds to the blind hole hb1. Thus, the keycap 110 can have better design sense to attract consumers' attention and improve market competitiveness.

### Second Embodiment

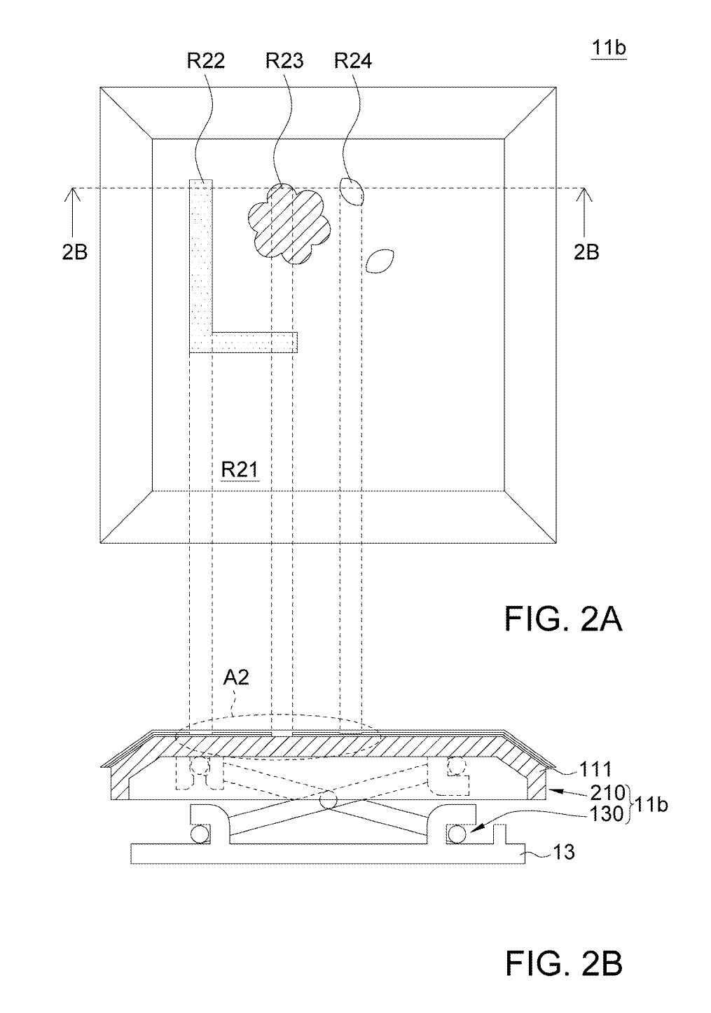

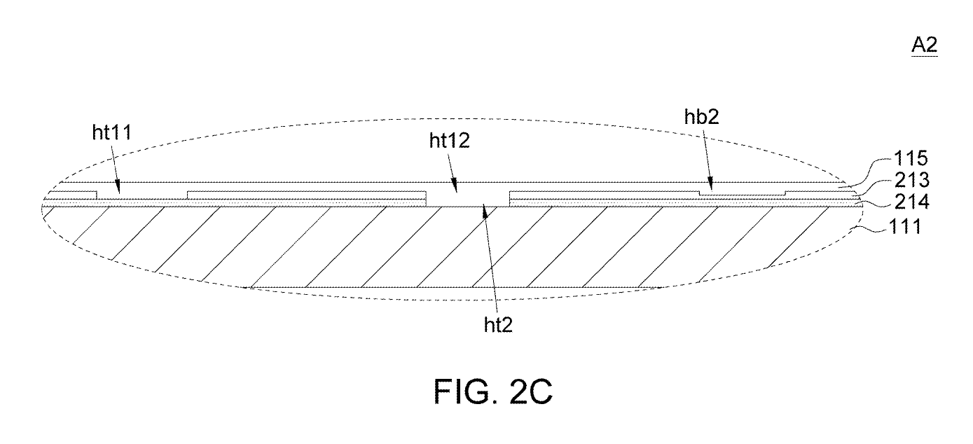

In comparison to the keycap 110 of the first embodiment, the keycap of the present embodiment of the invention further includes a second ink layer to increase the variations in color and disposition. Referring to FIG. 2A˜2C, a top view of a key group 11b according to a second embodiment of the present invention is shown in FIG. 2A, a cross-sectional view of the key group 11b along line 2B-2B in FIG. 2A is shown in FIG. 2B, and an enlargement of the region A2 in FIG. 2B is shown FIG. 2C.

In the present embodiment of the invention, a keycap 210 of the key group 11b includes a body 111, a first ink layer 213, a second ink layer 214 and a protection layer 115. The first ink layer 213 is disposed on the body 111, and has first through holes ht11 and ht12 and a blind hole hb2. The second ink layer 214 is disposed between the body 111 and the first ink layer 213, and is exposed from the first through hole ht11. In addition, the second ink layer 214 has a second through hole ht2, and the position of the second through hole ht2 corresponds to that of the first through hole ht12, so that the body 111 is exposed from the first through hole ht12 and the second through hole ht2.

The first through holes ht11 and ht12 and the blind hole hb2 can be designed to form special patterns on different region of the keycap 210. For example, as indicated in FIG. 2A, the first through hole ht11 is designed to form an English letter “L” (region R22), the first through hole ht12 and the corresponding second through hole ht2 is designed to form a floral pattern (region R23), and the blind hole hb2 is designed to form a leaf pattern (region R24). Since the depth of the first through hole ht11, the total depth of the first through hole ht12 and the corresponding second through hole ht12 and the depth of the blind hole hb2 are different, and the structures exposed from the first through hole ht11, the first through hole ht12 and the corresponding second through hole ht12 and the blind hole hb2 are different, the first through hole ht11, the first through hole ht12 and the corresponding second through hole ht2 and the blind hole hb2 can form different effects of lights and colors. In comparison to the keycap 110 of the first embodiment, the keycap 210 of the present embodiment of the invention not only possesses similar advantages like the keycap 110, through the disposition of the first through hole ht12 and the corresponding second through hole ht2, the keycap 210 provides richer colors and various lights to attract the user's attention. Besides, through the first through holes ht11 and ht12 and the blind hole hb2 of the first ink layer 213 and the second through hole ht2 of the second ink layer 214, the keycap 210 of the present embodiment of the invention further provide different choices of disposition with the regions R21, R22, R23 and R24. Thus, the keycap 210 can have better design sense to attract consumers' attention and improve market competitiveness.

### Third Embodiment

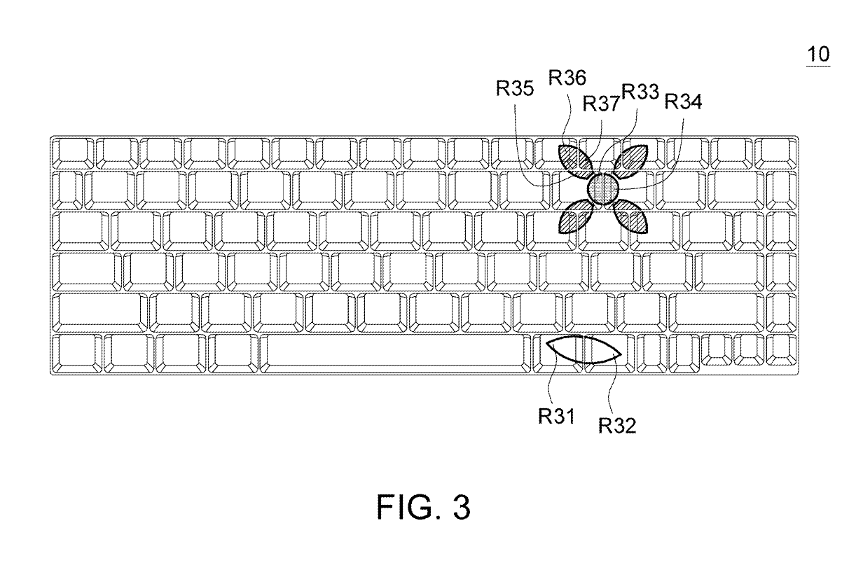

Referring to FIG. 3, a schematic view of a keyboard 10 according to a third embodiment of the present invention is shown. The keyboard 10 includes a base and several key groups based on the concepts of the first embodiment and the second embodiment.

Through the disposition of the key groups, the keyboard 10 of the present embodiment of the invention possesses similar advantages like the key group 11a of the first embodiment and the key group 11b of the second embodiment. The said advantages are achieved by one single key group.

In addition, the key groups can be arranged to form continuous pattern with the through holes and the blind holes. For example, the regions R31 and R32 corresponding to the blind holes of adjacent keycaps together form a leaf pattern. Or, the first through holes of adjacent keycaps expose the second ink layer, so that the corresponding regions R33 and R34 together form a floral pattern for example. Or, the first through hole and the corresponding second through hole of adjacent keycaps expose the body, so that the corresponding regions R35, R36 and R37 together form a pedal pattern. Thus, the outward appearances of the keyboard 10 are more versatile and aesthetic.

According to the keycap and the keyboard using the same disclosed in the embodiments of the invention, the through hole and the blind hole are formed on the ink layer to provide different choices of disposition. Thus, the keycap and keyboard using the same can have better design sense to attract consumers' attention and improve market competitiveness.

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A keycap, comprising:
a body; and
a first ink layer disposed on the body, wherein the first ink layer has a blind hole and a first through hole.

2. The keycap according to claim 1, wherein the body is exposed from the first through hole.

3. The keycap according to claim 1, further comprising:
a second ink layer disposed between the body and the first ink layer.

4. The keycap according to claim 3, wherein the second ink layer is exposed from the first through hole.

5. The keycap according to claim 3, wherein the second ink layer has a second through hole, and the position of the second through hole corresponds to the position of the first through hole, so that the body is exposed from the first through hole and the second through hole.

6. The keycap according to claim 1, further comprising:
a protection layer disposed on the first ink layer.

7. The keycap according to claim 6, wherein the protection layer is made from a transparent material.

8. A keyboard, comprising:
a base; and
a plurality of key groups disposed on the base, wherein each of the key groups comprises:
a restoring mechanism movably disposed on the base; and
a keycap coupled onto the restoring mechanism, wherein the keycap comprises:
a body; and
a first ink layer disposed on the body, wherein the first ink layer of at least one of the key groups has a blind hole and a first through hole.

9. The keyboard according to claim 8, wherein the body is exposed from the first through hole.

10. The keyboard according to claim 8, wherein the keycap further comprises:
a second ink layer disposed between the body and the first ink layer.

11. The keyboard according to claim 10, wherein the second ink layer is exposed from the first through hole.

12. The keyboard according to claim 10, wherein the second ink layer has a second through hole, and the position of the second through hole corresponds to the position of the first through hole, so that the body is exposed from the first through hole and the second through hole.

13. The keyboard according to claim 8, wherein the keycap further comprises:
a protection layer disposed on the first ink layer.

14. The keyboard according to claim 13, wherein the protection layer is made from a transparent material.

15. The keyboard according to claim 8, wherein each of the adjacent key groups has the blind hole, and the blind holes form a pattern.

16. The keyboard according to claim 8, wherein each of the adjacent key groups has the first through hole, and the first through holes form a pattern.
